(19) United States
(12) Patent Application Publication
(10) Pub. No.: US 2016/0134235 A1
(43) Pub. Date: May 12, 2016

(54) PHOTOVOLTAIC MODULE WITH INTEGRATED COOLING AND TRACKING SYSTEM

(71) Applicant: ANDES MINING & ENERGY CORPORATE S.A., Santiago (CL)

(72) Inventor: Rolf SCHUMACHER, Santiago (CL)

(73) Assignee: ANDES MINING & ENERGY CORPORATION S.A., Santiago (CL)

(21) Appl. No.: 14/898,629

(22) PCT Filed: Jun. 17, 2014
(86) PCT No.: PCT/IB2014/062304

§ 371 Date: Dec. 15, 2015

Related U.S. Application Data
(60) Provisional application No. 61/835,977, filed on Jun. 17, 2013.

(51) Int. Cl. H02S 40/42; H02S 20/32; H02S 30/10

(52) U.S. Cl. CPC H02S 40/425; H02S 30/10; H02S 20/32

(57) ABSTRACT

Photovoltaic (PV) power generation systems and methods are disclosed, wherein the system includes a PV module having an integrated frame structure, PV cell rows, solar tracking system, and cooling system. A protective cover may be included with the frame structure to form an enclosed area in which the PC cell rows, cooling system, and tracking system are placed, thereby protecting them from the elements. The cooling system may be a water circulation based cooling system, and the integrated frame of the PV module may be directly mounted on a foundation consisting of a water tank. The water tank may serve as the storage unit for the water cooling system, with the water from the tank being pumped through the cooling profiles at each cell row in the frame and then returned to the tank. Other mounting structures may also form the foundation for the integrated frame.

### CROSS-REFERENCE TO RELATED APPLICATIONS

This application claims the benefit of U.S. Provisional Application No. 61/835,977, filed Jun. 17, 2013, entitled PHOTOVOLTAIC MODULE AND INTEGRATED COOLING AND TRACKING SYSTEM, which is incorporated herein by reference in its entirety.

### TECHNICAL FIELD

The present invention is directed to a photovoltaic power generation system and method, and in particular to photovoltaic module with a cooling system and tracking system integrated within the frame.

### BACKGROUND OF THE INVENTION

Photovoltaic (PV) power generation has played an increased role in the power generation market during recent years. Originally, PV was designed and used off of the existing power distribution grid, particularly for off grid applications where an electrical connection was difficult or expensive to implement. For example, PV has been used as a power supply with battery systems for different types of signals, for power generation in off-grid locations with medium or low consumption, or where an electrical connection to the existing, traditional power grid is impossible, such as in the space industry. The demand for renewable energy sources has led to advancements in the technology and manufacturing capabilities surrounding PV increased, resulting in decreased costs of implementing PV systems.

To increase the efficiency of power generation, prior art PV systems have implemented solar tracking systems to orient the PV cells towards the sun at all times. The trackers minimize the angle of incidence between incoming sunlight and the PV cells, thereby increasing the amount of energy produced. Many tracking systems currently used are dual-axis systems, which track both daily east-west motions of the sun and seasonal north-south changes in the sun's position in the sky. Single-axis tracking systems have also been implemented and are often less costly than the dual-axis systems. However, the addition of either a single-axis or dual-axis tracking system to a PV system adds significant expense and complexity to the overall system. Due to harsh conditions in the field, such as wind, rain, dust, and temperature extremes, the tracking systems utilized by the prior art are often complex, incorporate significant amounts of materials to stand up to the elements, and require expensive installation and maintenance. This increase in costs and expenses leads to a significant increase in the cost per KW of power generated, and may deter a more expansive use of PV technology.

A significant portion of the sunlight absorbed by many PV cells or panels is exhausted as heat, which can reduce the overall efficiency of the system as the components heat up. In regions with high solar radiation values and high ambient temperatures, the yearly average temperature losses in a PV system can reach values above 10% of yearly energy yield. The temperature losses in tracked PV systems can be even higher, as the radiation on the PV surface is higher and a greater portion of the solar radiation energy is converted to heat. These losses are caused by the negative temperature gradient in the modules used in the PV cells, which are typically poly or mono crystalline Silicon Modules. Therefore, cooling systems have been implemented in prior art PV systems, which are used to draw this excess heat away from the PV components. These include both direct and indirect cooling, systems, such as finned heat sinks and heat exchanger systems using fluid circulation. However, as with the dual-axis tracking systems, these cooling systems are often complex and add significant structure and expense. Depending on the type of cooling system used, exposure to the elements may again necessitate either more complex and expensive equipment that can withstand the elements, or additional protective structures.

What is needed is a PV system that provides sufficient efficiency and power generation, but at a reduced cost of existing PV systems. The PV system and method described herein allow for competitive power generation at a significantly reduced cost when compared to existing PV systems through the use of a photovoltaic module including a frame with integrated PV cells, solar tracker system, and cooling system.

### SUMMARY

The present application is directed to a PV system and method with reduced costs and increased efficiency. The PV system includes a PV module including an integrated frame structure, PV cell rows, solar tracking system, and cooling system. According to some embodiments, the cooling system may be a water circulation based cooling system, and the water storage tank may also be integrated in the frame structure which supports the PV cell rows. In other embodiments, the frame structure may be mounted on standard piles driven into the ground or other traditional mounting structures, such as screw foundations or concrete foundations.

The tracking system is preferably a dual-axis tracking system, although a simplified system using only a single-axis east-west tracking system may also be used. According to some embodiments, the tracking system is simple and easy to maintain, which may include push rods for east-west movement of the cell rows and a simple inclination tracker using a central torsion bar for north-south movement of the entire frame structure. The frame structure may form an enclosed area in which the PC cell rows, cooling system, and at least the east-west tracking system are placed. This enclosed area protects the components from the elements, thereby reducing the amount of material required for each component, reducing the cost of the materials used, and reducing maintenance expenses.

The integrated cooling system along with the simple and easy to maintain dual-axis tracking system allow for increased efficiency of the PV system at a substantially reduced cost when compared to prior art systems. The PV system and method further provides reduced costs as compared to prior art PV systems through reduced costs of the support structure, reduced costs of the protected cell arrangement, increased pre-assembly of the module with the integrated frame, tracking system, and cooling system, and the optional addition of an integrated water tank foundation.

### BRIEF DESCRIPTION OF THE DRAWINGS

FIG. 1A is an illustration of a PV module with integrated tracking and cooling systems.

FIG. 1B is an illustration of the interior of the frame of a PV module.

FIG. 2 is an illustration of a PV module with a water tank as an integrated foundation.

FIG. 3 is an illustration of a cooling profile and support structure for a PV cell row.

FIGS. 4A and 4B are illustrations of a support column and rotating bearing used with PV cell rows.

FIG. 5 is an illustration of the east-west tracking system using a central push rod and module levers.

FIG. 6 is an illustration of the east-west tracking system using one central push rod installed under multiple PV modules.

FIG. 7 is an illustration of the north-south inclination tracking system using a central torsion bar.

FIG. 8 is an illustration of the PV frame structure installed using, an integrated water tank as the foundation.

FIG. 9 is an illustration of a standard prior art PV module.

FIGS. 10A and 10B are illustrations of a completed module containing multiple PV cell rows and a PV cell row, respectively.

### DETAILED DESCRIPTION

A PV system and method for efficiently generating electrical power are disclosed. The PV system includes a frame with a protective cover, creating a protected enclosed area within the frame. According to some embodiments, the protective cover may be a plate formed of glass, Plexiglas, or other clear material. Inside of the enclosed area within the frame, several rows of PV cells are installed, which have an integrated tracking system to follow the sun's daily movements from east to west and rotate the cell rows accordingly. In addition, a north-south tracker may be installed allowing the complete frame to be tracked north-south to compensate for the variation of the solar path as the seasons change. A cooling system may be integrated into the frame, with each row of PV cells being cooled by a profile which is filled with water. According to some embodiments, the profile is made of metal, although other materials such as plastic may be used. The integrated frame may be mounted on a standard foundation, such as three pillars driven into the ground. Alternatively, the integrated frame may be directly mounted on, and integrated with, a foundation consisting of a water tank. In this embodiment, the water tank may serve as the storage unit for the water cooling system, with the water from the tank being pumped through the cooling profiles at each cell row in the frame and then returned to the tank.

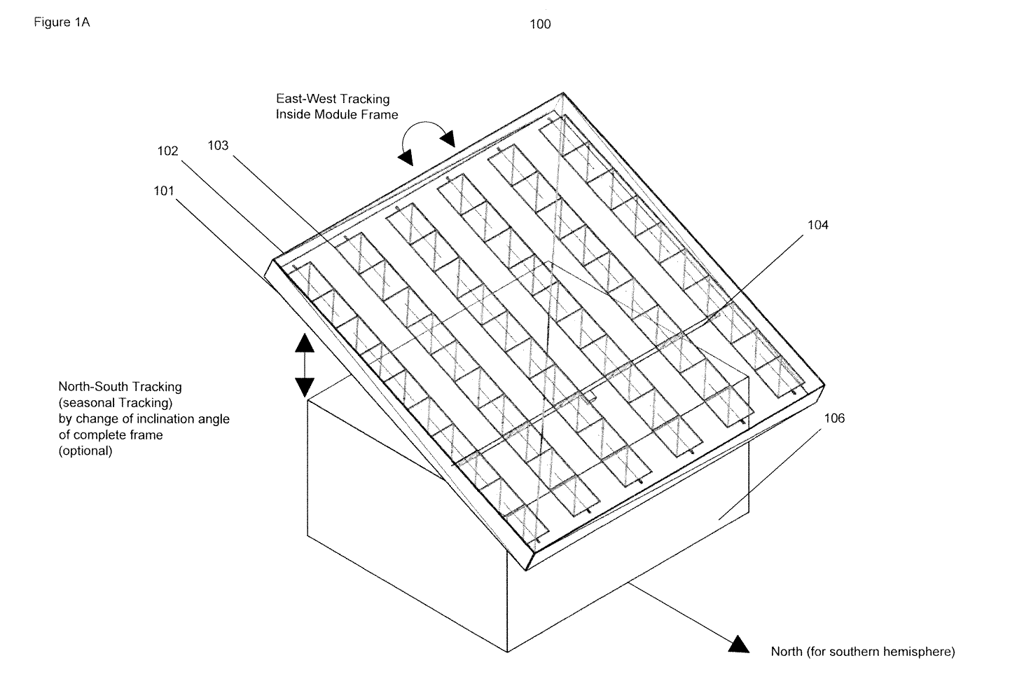

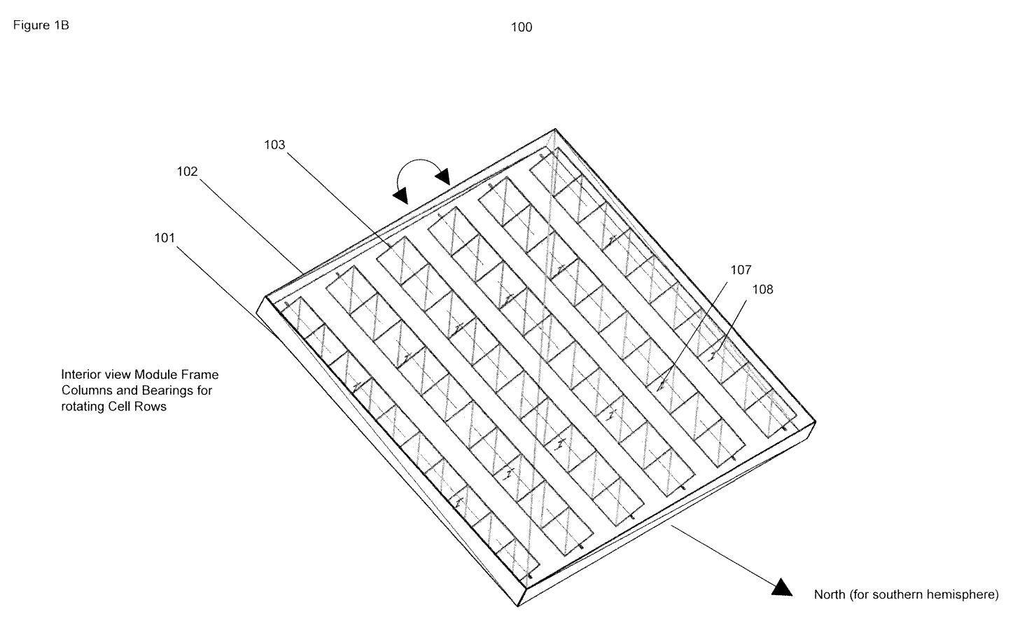

FIG. 1A illustrates an embodiment of the PV module with integrated tracking and cooling systems. As seen in FIG. 1A, the PV system 100 includes a frame 101, protective cover 102, PV cell rows 103, an east-west solar tracking 104 within the frame 101 and protective cover 102, and a north-south azimuth tracker 105 for moving the complete frame 102. The frame 102 is mounted on a foundation structure 106. Each cell row 103 is cooled by a profile filled with water, as described in more detail below.

FIG. 1B shows a detailed view of the interior of frame 101 within protective cover 102. As shown in FIG. 1B, the frame 101 supports multiple rows of PV cells 103, each of which may be mounted on a support column 107, 108 within the enclosed area formed by the frame 101 and protective cover 102. The support columns 107, 108 may include rotating or pivoting attachment pieces, allowing the PC cells to rotate within an east-west tracker system.

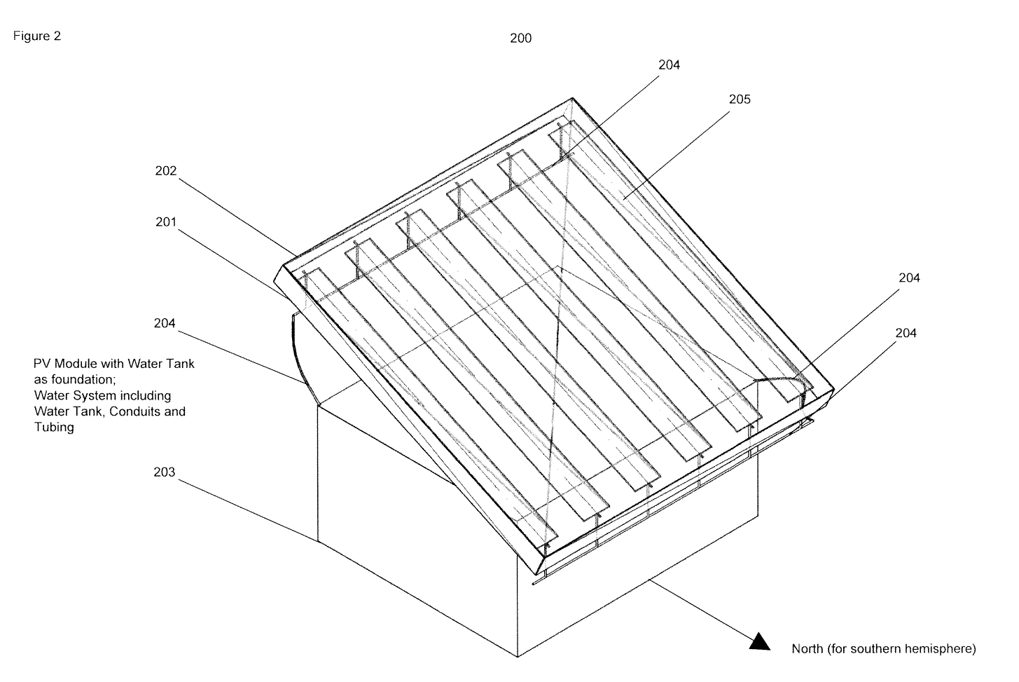

FIG. 2 is an illustration of the PV module when mounted on an integrated foundation consisting of a water tank. As shown in FIG. 2, the PV system 200 includes a frame 201 and protective cover 202, similar to the system shown in FIG. 1. The PV cells and east-west tracker are included within the enclosed frame space under the protective cover 202. An integrated foundation consisting of a water tank 203 is provided, wherein the frame 202 is mounted directly to this water tank 203. The water tank 203 may be installed directly on leveled soil, and when filled with water provides sufficient stability for the PV module such that no additional foundation is necessary to support the frame structure. A structural stability calculation may be performed to confirm the necessary weight depending on the size of the PV frame structure and the maximum wind load at installation location. In addition to providing a foundation and stability for the frame 201, the water tank 203 may be used as storage for a water cooling system wherein water from the tank 203 is pumped through conduits 204 into profiles at each PV cell row under the protective cover 202. The water in the profiles absorbs excess heat from the PC cell rows, and returns to the water tank 203. The profiles may be metal profiles, or may be made of plastic or any other material capable of holding a cooling liquid. According to some embodiments, the water may be cycled through the metal profiles continuously once the solar radiation reaches a predetermined level. Although the water in the tank will heat up from this process during the day, the water has sufficient time during the evening and night to cool down. If necessary, the water may also be cycled during the night and the PV modules may act as a cooling surface to bring the water temperature down. A water cooling system for each PV cell row may be installed in the PV system. A tubing system may be used within the frame 201, connecting a water inlet and outlet of the metal profile of each PV cell row to a central water pipe 206. The central water pipe may be filled from one side using a water pump integrated with the PV system, while the other side of the central water pipe is connected directly into the water tank 203. In embodiments where a standard foundation is used, the water tank used in the cooling system may be placed in close proximity to the frame 201. In such embodiments, the water pump may be connected to the water tank instead of the PV module. Because the interior of the frame 201 is protected from ambient conditions by cover 202, cost competitive materials can be used for the components of the water cooling system.

According to some embodiments, there may be a single, central pipe connecting multiple PV modules. The central pipe may be connected to a single pump, such as a low pressure cycling pump, supplying water to the multiple PV modules. In other embodiments, multiple pumps may be used to cycle water through the plurality of PV modules. A flexible connection may connect the central pipe to secondary pipes attached to the frame of each of the PV modules. Each secondary pipe on the individual PV modules may be connected to the profiles at the PV cell rows using small tubes. A receiver pipe may be connected to tubes at the end of each cell row, wherein water that has cycled through the profiles is passed from the tubes into the receiver pipe. Each receiver pipe may be connected to a water tank using a flexible connection. There may be a separate water tank at each PV module, or multiple PV modules can be connected to the same water tank. An overflow and additional tubing and piping may be installed at each water tank so that water may flow back to the pump for recirculation through the PV modules.

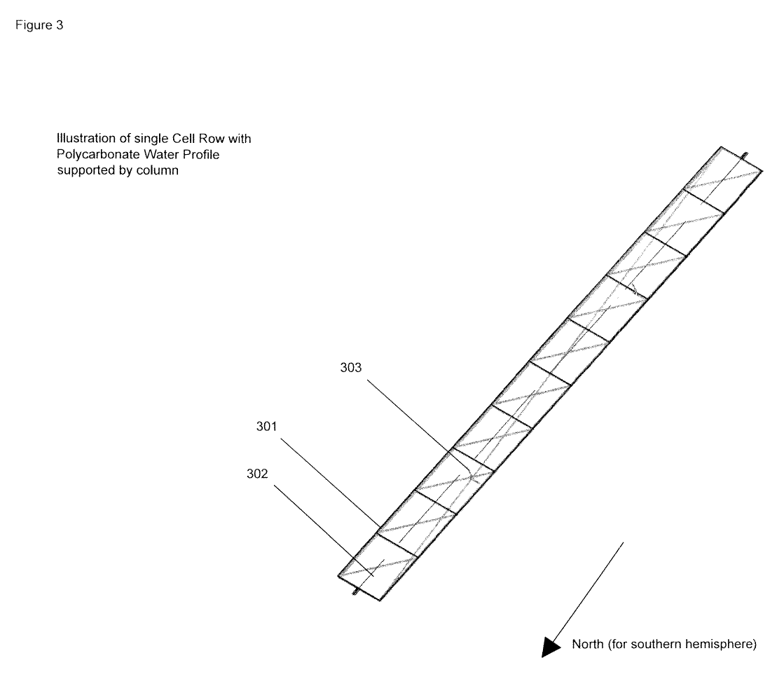

FIG. 3 illustrates an example of the metal profile of a cooling system connected to one of the PC cell rows that are included within the frame. As shown in FIG. 3, multiple PV cells 301 may be connected together to form a row. Underneath this row, a metal profile 302 may be provided, which is filled with water as described above. Support columns 303 may be connected to the PV cell row, and may allow for rotation to follow the east-west movement of the sun according to an east-west tracking component.

In addition to the cooling system, the PV system may include an easy to maintain dual-axis tracking system. Within the dual-axis tracking system, the PV cell rows may follow the sun from east to west during the daily cycle, while the yearly change in the sun's azimuth is compensated with a change of the inclination of the entire frame structure in the north-south direction. The east-west tracking system component is installed underneath of the protective cover, thereby protecting the components from the elements. Because the components are protected within the enclosed area of the frame underneath the protected cover, the moving parts of the east-west tracking system do not have to be designed to meet extreme ambient conditions. For example, prior art tracking system components, which are exposed to the elements, are typically designed for maximum winds of up to 40 m/s. The moving parts of these prior art tracking systems are also exposed to rain, dust and other elements year round, which can lead to components breaking and increased maintenance costs. Designing components to withstand the elements may require stronger or additional materials and have higher costs than the east-west tracking system of the present invention, which is protected from the elements within the covered frame.

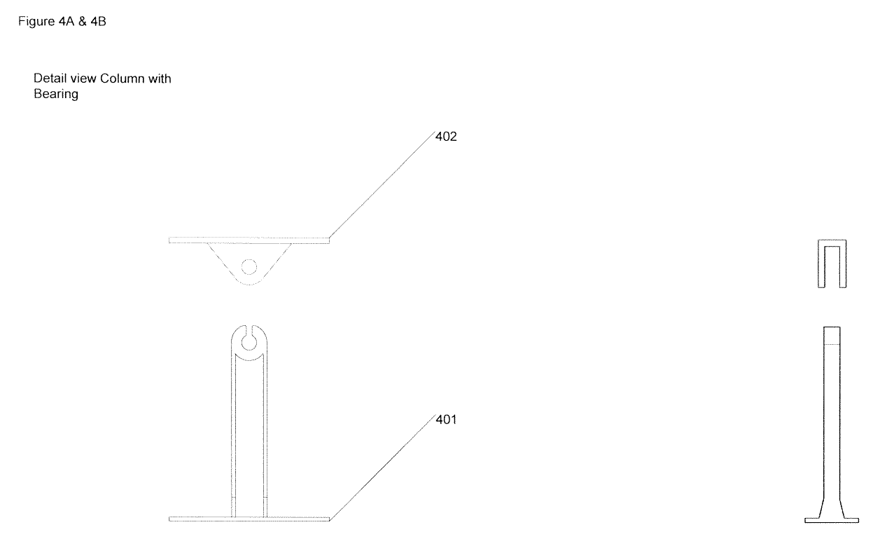

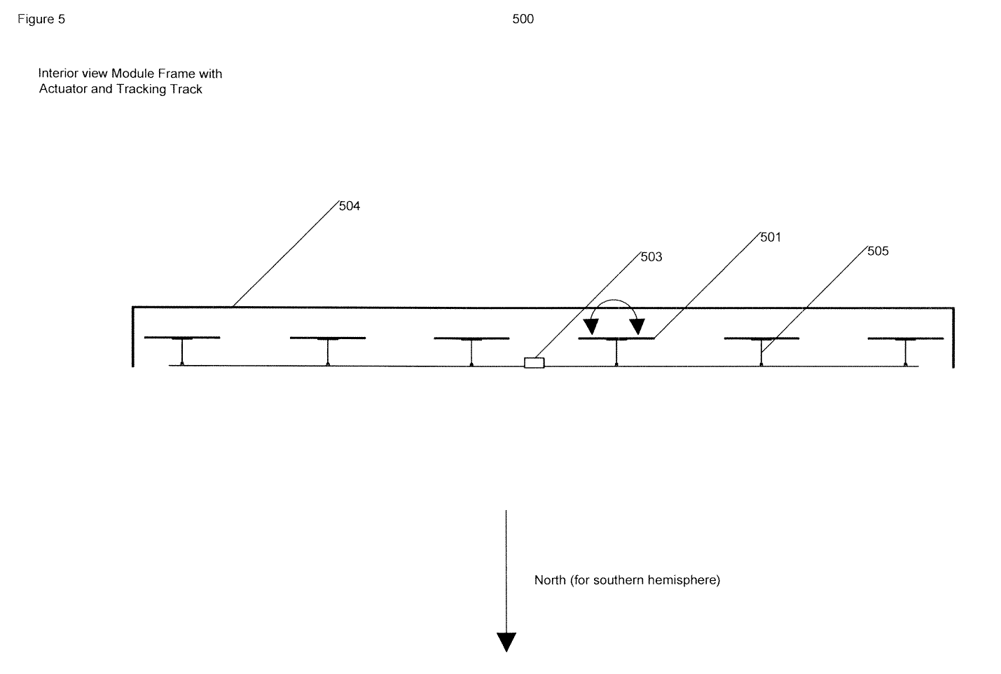

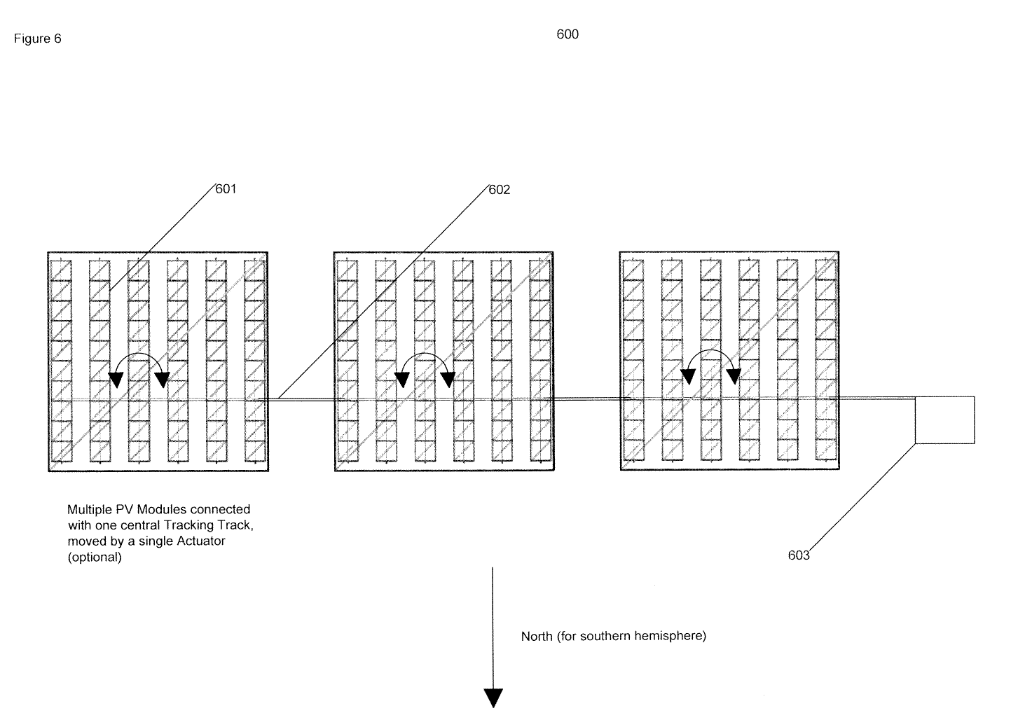

Each PV cell row may have a simple bearing system, formed of a rotating piece mounted on top of a support column, as seen in FIGS. 4A and 4B. Each support column 401 may include a rotating piece 402 attached at the top. FIG. 4A shows the rotating piece and column from a front view, while 4B shows a side view. The support column 401 may be made from an injected molded plastic, having high flexibility and low costs. In addition, the protected design of the PV system means that the forces required to move the components are minimal. The PV system may use a push rod and lever system, as shown in FIGS. 5 and 6. Using the push rod and lever system, one servo per PV module can adjust all of the PV cell rows within that module. Multiple modules may be installed in a row with one central push rod running through each of the plurality of modules to adjust the PV cells rows in each module. As seen in FIG. 5, the push rod and lever system may include a central push rod 502, which is connected to module levers 503 that rotate the PC cell rows 501 in each PV module. As shown, these components of the east-west tracking system are all underneath of the protective cover 504, keeping them protected from the elements. Motion of the module lever causes the rotating piece attached to the PV cells to rotate, thereby adjusting the position of each PV cell row to follow the east-west motion of the sun. FIG. 6 illustrates an example of using a single central push rod with multiple PV modules. In FIG. 6, four PV modules 600 are installed in a row, with each module containing multiple PV cell rows 601. A central push rod 602 is installed underneath the modules, which moves the levers 603 within each module to rotate the PV cells to follow the east-west motion of the sun.

According to some embodiments of the invention, the PV system may contain only single axis tracking using the east-west tracking system described above. This embodiment allows for a reduction of costs and complexity of the system, as the north-south tracking components would not be required. An optimized fixed inclination of the frame module may add increased efficiency to the yearly production.

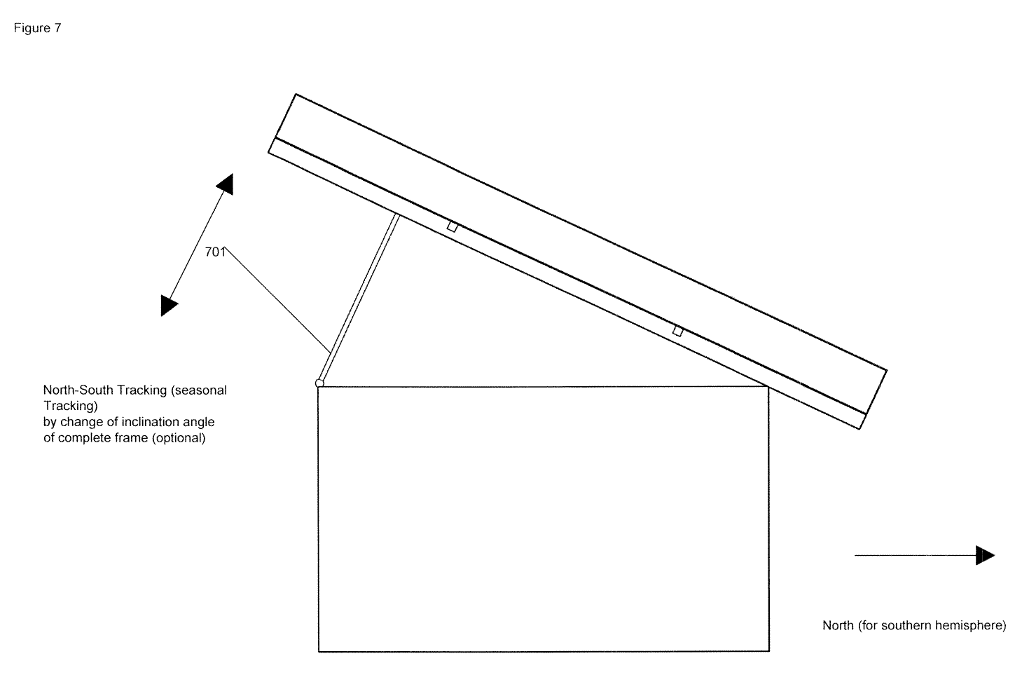

When using dual-axis tracking, a north-south tracking is additionally included. This north-south tracking system allows the frame to change inclination in accordance with changes in the sun's path as the seasons change. These inclination changes require only very little movement during the day, as the main movement is only seen between the different seasons of the year. As shown in FIG. 7, the inclination tracker may be implemented using a standard linear actuator 701.

As described above, the PV cells in the present invention are installed in a frame underneath of a protective cover, such as a glass plate. This protective cover adds significant benefits to the overall structure of the PV module and its foundation. The sensitive PV cells, which may be mounted on profiles, may be connected to the main frame with a simple flexible support column and bearing, as shown in FIGS. 4A-4B. The support and bearing may be made of injected molded plastic, which are enclosed under the protective cover and serve to mechanically disconnect the PV cells from the frame. Therefore, the outer frame of the each PV module can be designed with lower stiffness requirements than standard PV systems because the forces related to potential movement of the frame will not be transferred to the PV cells. Instead, these movements of the frame will be compensated for by the support column and bearing structures.

Additionally, the protected enclosure within the frame allows for the use of cost competitive internal parts based on the low mechanical forces and protection from ambient conditions. The reduced stiffness requirements of the frame allow for decreased costs in comparison to standard PV structures, as the standard structures typically require very high stiffness to avoid stresses in the PV cell areas. Accordingly, less material is required in the PV system of the present invention due to the lower mechanical requirements. The use of a glass protective cover in the present invention may also reduce the overall costs as compared to standard PV systems.

PV modules in standard systems are directly exposed to the elements, and therefore the modules can be deformed by strong winds. In these standard systems, one fundamental function of glass used is to increase the mechanical stability and stiffness of the module to avoid unnecessary bending stresses to the PV cells. In contrast, the PV cells of the present invention may be installed on a rigid profile inside of an enclosed area beneath a protective cover as described above. Therefore, any bending of the frame is absorbed by the flexible mounting components and the frame itself. The PV cells, which are attached to the rigid profiles, remain unbended. Based on the lower stiffness requirements of the present invention, the flexible frame of the present invention may also be made out of more cost-effective materials such as wood or thin galvanized metal profiles with optimized shapes instead of the typical expensive aluminium frames of standard PV systems.

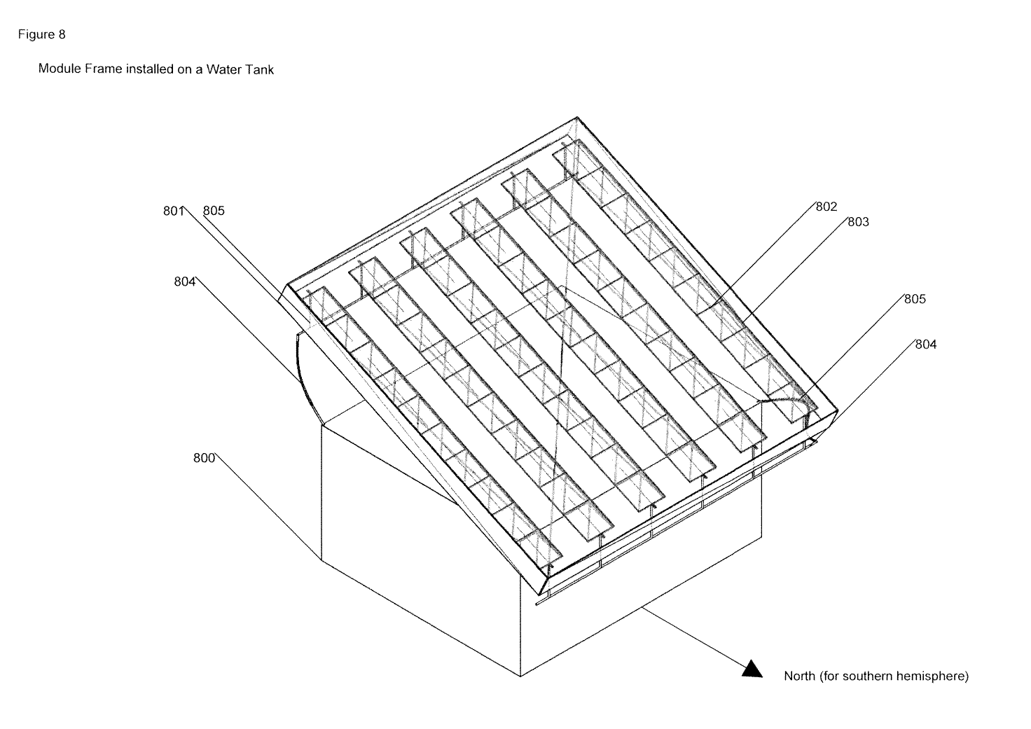

The present invention also allows for reduced costs of the support structure and on-site work required to install a PV system when compared to standard systems. The costs of the structural materials and on-site installation have become an increasing portion of the overall costs of PV power plants. Although there has been a reduction in the costs of PV modules themselves, the costs of the metal and other materials used for the structures required for the installation are not decreasing at the same rate. In contrast to these standard systems, the frame of the present invention is an integral part of the PV module structure. Therefore, placing the PV system at a location only requires the installation of a water tank foundation. This leads to less material handling at the installation site, and reduced costs and time in implementing a PV power system. As seen in FIG. 8, the foundation may include a water tank 800, on which the frame 801 is installed. The water tank may be made of standard galvanized metal sheets with a support frame. The rows of PV cells 802 with the integrated metal profiles for the water cooling system may be installed within the frame. Tubing 803 and pipes 804, 805 guide the flow of water from the tank through the metal profiles to cool the PV cell components.

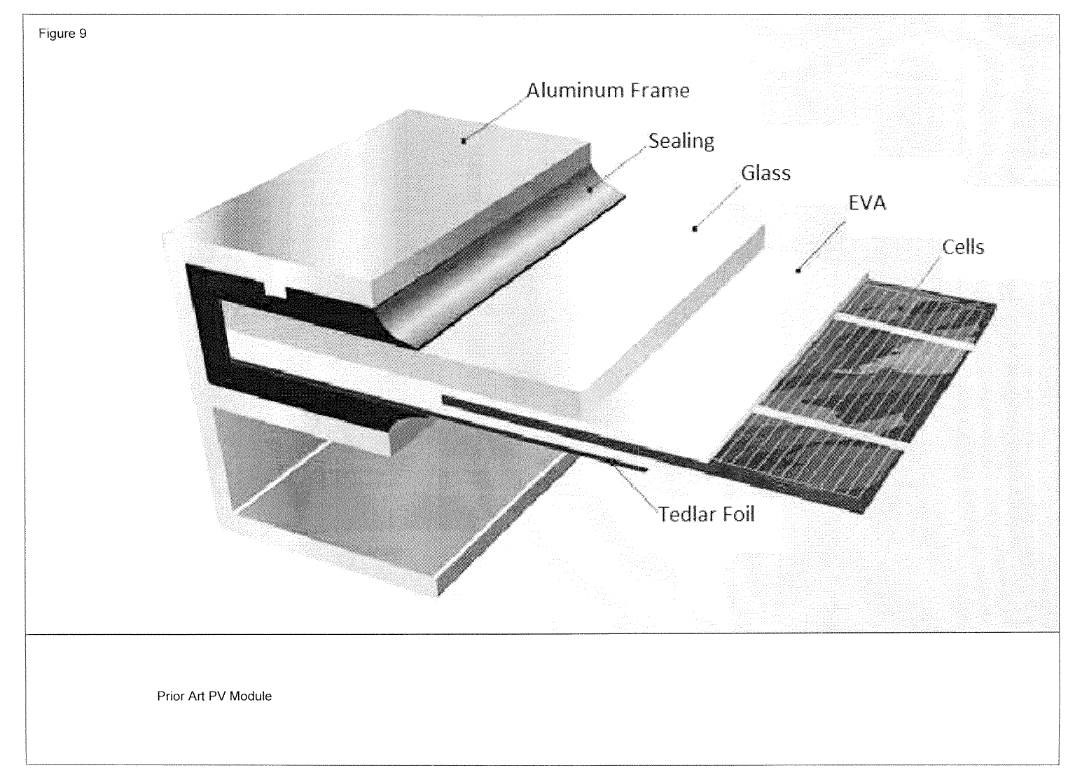

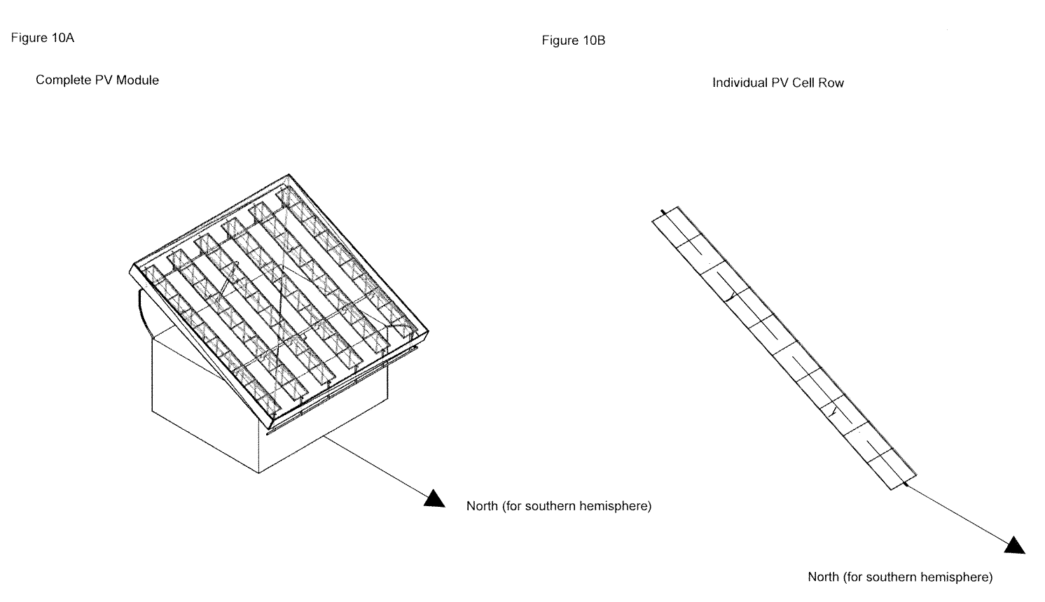

The present invention further allows for reduced costs of the PV cell rows used within the frame structure as compared to standard PV modules. FIG. 9 is an illustration of a typical PV module, while FIGS. 10A and 10B show a completed PV module comprising multiple PV cell rows of the present invention, as well as an individual PV cell row. In the present invention, the PV cell rows are installed within the protected enclosed area of the frame structure, allowing for simplified production and less material for the sensitive PV components. In contrast to the standard PV modules shown in FIG. 9, the PV cell rows of the present invention do not require an individual aluminum frame, glass, and sealing. Although additional materials may be required to form the integrated frame with protective cover of the present invention, the integrated frame is used as part of the support and tracking structure of the PV module, thereby reducing the overall costs and materials required for the PV power plant.

In the foregoing, the invention has been described with reference to particular embodiments. However, it is evident that various modification and changes may be made thereto without departing from the broader scope of the invention.

1-10. (canceled)

11. A photovoltaic power generation system comprising:
a. a frame with a base and four walls;
b. at least one protective cover configured to fit over the four walls of the frame, creating an enclosed area between the cover, frame base, and frame walls;
c. at least one row of photovoltaic cells within the enclosed area;
d. an east-west solar tracker system located in the enclosed area underneath the protective cover; and
e. a cooling system configured to cool the photovoltaic cells, wherein the cooling system comprises profiles filled with a cooling liquid.

12. The photovoltaic power generation system of claim 11, further comprising a support foundation on which the frame is attached.

13. The photovoltaic power generation system of claim 12, wherein the support foundation is a cooling liquid tank.

14. The photovoltaic power generation system of claim 13, wherein the cooling liquid tank supplies the cooling liquid used in the cooling system.

15. The photovoltaic power generation system of claim 11, further comprising a north-south solar tracker configured to adjust the inclination of the frame.

16. The photovoltaic power generation system of claim 11, further comprising support piles on which the frame is attached.

17.-19. (canceled)

20. A method for providing photovoltaic power generation, the method comprising:
a. providing a frame with a base and four walls;
b. attaching at least one protective cover to the four walls of the frame, creating an enclosed area between the cover, frame base, and frame walls;
c. providing at least one row of photovoltaic cells within the enclosed area;
d. providing an east-west solar tracker system located in the enclosed area underneath the protective cover; and
e. providing profiles within the structures under the protective cover, wherein the profiles are configured to circulate a cooling liquid to cool the photovoltaic cells.

21. The method of claim 20, further comprising attaching the frame to a cooling liquid tank, wherein the cooling liquid tank serves as a foundation for supporting the frame, photovoltaic cells, and east-west tracker.

22. The method of claim 21, wherein liquid from the cooling liquid tank is circulated through the profiles to cool the photovoltaic cells.

23. The method of claim 20, further comprising installing support piles into the ground, and attaching the frame to the support piles.

24. The method of claim 20 wherein the cooling liquid is water.

25. The method of claim 21 wherein the cooling liquid tank is a water tank.

26. The method of claim 22 wherein the cooling liquid is water.
